(19) United States
(12) Patent Application Publication
(10) Pub. No.: US 2007/0067088 A1
(43) Pub. Date: Mar. 22, 2007

(54) In-vehicle multifunctional information device

(76) Inventor: Kwang Baig, Seoul (KR)

Correspondence Address: CANTOR COLBURN, LLP, 55 GRIFFIN ROAD SOUTH, BLOOMFIELD, CT, 06002, US

(21) Appl. No.: 11/387,666

(22) Filed: Mar. 23, 2006

(30) Foreign Application Priority Data
Sep. 16, 2005 (KR) 10-2005-0086859

(51) Int. Cl. G06F 17/00

(52) U.S. Cl. 701/96; 701/2

(57) ABSTRACT

An in-vehicle multifunctional information device provides not only an audio function but also a variety of multimedia content and vehicle state information to the driver. The device includes a main body, a monitor, and an input panel. The main body includes a main controller for controlling the overall operation of the device, selectively receiving and outputting a broadcast signal, and providing a plurality of user applications. The monitor outputs a broadcast signal provided from the main body or outputs content reproduced by a user application. The input panel is coupled to the front side of the main body such that it opens and closes. The input panel includes a sub controller for displaying a user application menu provided from the main body, receiving and processing an operating command input by the user, and detecting starting or stopping of the vehicle's engine and controlling the operation of the main body.

### BACKGROUND OF THE INVENTION

1. Field of the Invention

The present invention relates to an in-vehicle multifunction information device, and more particularly to an in-vehicle multifunctional information device that can provide not only an audio function but also a variety of multimedia content and vehicle state information to a driver.

2. Description of the Related Art

Most vehicles have a car audio unit to listen to the radio or music. The driver can obtain information from a terrestrial radio signal received through the car audio unit and can listen to music from a music CD or cassette tape in the car audio unit, providing entertainment while driving the vehicle.

As technologies for high image quality, small-size liquid crystal displays have been developed, in-vehicle TVs having TV tuners for receiving and outputting terrestrial broadcast signals have been developed and provided to users.

In-vehicle navigation systems have also been developed to offer convenience to drivers when driving vehicles. The in-vehicle navigation system is a system that receives a destination input by the user and conducts route guidance to the destination. Most of the navigation systems receive GPS signals from a GPS satellite, calculates the current position of a vehicle that is traveling, calculates a route with the shortest distance to the destination, and displays the calculated route on a map or conducts voice guidance of the route.

With development of audio and video compression technologies such as MP3 and MPEG4, a variety of portable multimedia devices have been developed and have gained great popularity.

However, in order to use the navigation system and multimedia data, the driver must individually purchase devices necessary for them. In addition, in order to attach the purchased devices to the vehicle and to allow them to cooperate with the car audio unit, the driver must use separate connection equipment or attaching means.

The driver may be distracted from driving when operating a variety of devices installed around the driver's seat. In addition, a number of dedicated holders used to fix the variety of devices to the interior of the vehicle defile the internal appearance of the vehicle.

An in-vehicle multimedia device, which is commonly referred to as a car PC, has been developed to overcome these problems. The car PC reproduces and provides a variety of multimedia data. However, the car PC has a problem in that the user operates the car PC separately from driving the vehicle since the operation of the car PC is controlled separately from the vehicle.

In addition, changes in the state of the vehicle greatly affect the car PC since the overall operation of the car PC is controlled using a single controller, for example, a CPU.

For example, fluctuating power may be supplied to the car PC due to the limited environment of the car PC inside the vehicle. The car PC has no way to prevent a power supply overload or an increase in the temperature of the power supply above a specified temperature, which may cause a failure in the car PC.

### SUMMARY OF THE INVENTION

Therefore, the present invention has been made in view of the above problems, and it is an object of the present invention to provide an in-vehicle multifunctional information device that can not only receive terrestrial TV and radio broadcasts but also provide a variety of multimedia content to the user.

It is another object of the present invention to provide an in-vehicle multifunctional information device that has a sub controller to detect and provide states of the vehicle to the user and to detect starting or stopping of the engine of the vehicle, in addition to a main controller to control the overall operation of the in-vehicle multifunctional information device.

In accordance with the present invention, the above and other objects can be accomplished by the provision of an in-vehicle multifunctional information device comprising a main body including a main controller for controlling overall operations of the in-vehicle multifunctional information device, selectively receiving and outputting a broadcast signal, and providing a plurality of user applications; a monitor for outputting a broadcast signal output from the main body or outputting content reproduced by a user application; and an input panel coupled to a front side of the main body such that the input panel opens and closes, the input panel including a sub controller for displaying a user application menu provided from the main body, receiving and processing an operating command input by a user, and detecting starting or stopping of an engine of a vehicle and controlling an operation of the main body.

The input panel is attached to the front side of the main body such that the input panel opens and closes. The in-vehicle multifunctional information device is inserted in a space that is formed in the vehicle to install a car audio unit. When starting of the engine of the vehicle is detected by the input panel, the monitor, which has been housed in a receiving space, is slid out of the receiving space.

When the in-vehicle multifunctional information device is activated, a user application menu provided by the main body according to an operating program stored in a memory provided in the main body is displayed on the monitor. The user inputs a command to run a desired application through a touch screen of the monitor or through the input panel and the main body receives the command and runs the application.

User applications provided by the main body include a player required to reproduce terrestrial TV and radio broadcasts and music or video, a car navigation application, a wireless Internet browser, etc.

In a characteristic aspect of the present invention, the in-vehicle multifunctional information device includes individual controllers for the main body and the input panel, which are referred to as main and sub controllers. The sub controller provided in the input panel detects starting or stopping of the engine of the vehicle and controls the operation of the in-vehicle multifunctional information device.

Preferably, the input panel includes one or more navigation keys, a touch pad, and a sub controller. The navigation keys receive an operating command from the user. The touch pad displays state information of the main body, state information of the vehicle provided by a vehicle state detector, and a user application menu provided by the main body. The touch pad receives and outputs selection information of an application on the menu from the user. The touch pad supports a pointing device function of a user interface provided through the monitor. The sub controller includes an input signal processor that processes an input signal from the touch pad and an operation controller that detects starting or stopping of the engine of the vehicle and controls the operation of the in-vehicle multifunctional information device.

According to the present invention, the single in-vehicle multifunctional information device not only functions as a car audio unit but also provides a variety of multimedia content to the user so that there is no need to install a number of multimedia devices in the vehicle. The main body controls the overall operation of the in-vehicle multifunctional information device while the sub controller in the input panel controls the operation of the main body, so that the system can be kept more stable.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically shows an in-vehicle multifunctional information device according to a preferred embodiment of the present invention;

FIG. 2 is a block diagram schematically showing a main body and a monitor shown in FIG. 1;

FIG. 3 is a view schematically illustrating a user application that is provided through the monitor according to a preferred embodiment of the present invention;

FIG. 4 is a schematic block diagram of an input panel shown in FIG. 1; and

FIG. 5 is a view schematically showing menus displayed on a touch pad of the input panel shown in FIG. 4.

### DESCRIPTION OF THE PREFERRED EMBODIMENTS

Now, preferred embodiments of the present invention will be described in detail with reference to the accompanying drawings so that the present invention will be easily understood and realized by those skilled in the art.

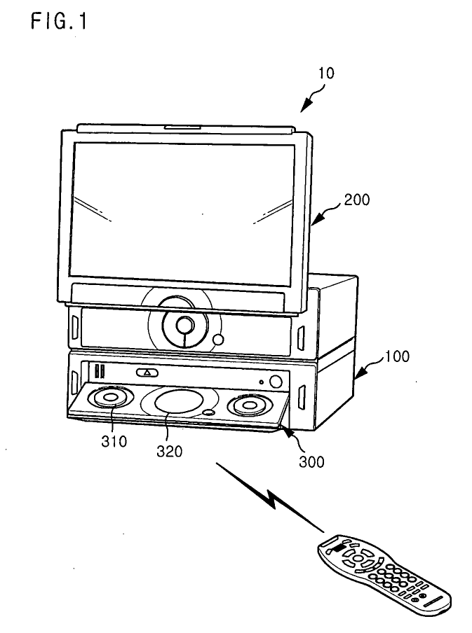

FIG. 1 schematically shows an in-vehicle multifunctional information device according to a preferred embodiment of the present invention. The in-vehicle multifunctional information device 10 according to the present invention is preferably designed to have a suitable size for insertion in a car audio unit receiving space that is formed in the vehicle to receive a car audio unit. As shown in FIG. 1, the in-vehicle multifunctional information device 10 includes a main body 100, a monitor 200, and an input panel 300. The main body 100 controls the overall operation of the in-vehicle multifunctional information device 10, selectively receives and outputs a terrestrial broadcast signal, and provides a plurality of user applications. The monitor 200 outputs a broadcast signal output from the main body 100 or content reproduced by a user application. The input panel 300 is coupled to the front side of the main body 100 such that it is slidably opened and closed. The input panel 300 displays a user application menu provided from the main body 100 and receives and processes an operating command input by the user. The input panel 300 includes a sub controller 330 for detecting starting or stopping of the engine of the vehicle and controlling the operation of the main body 100.

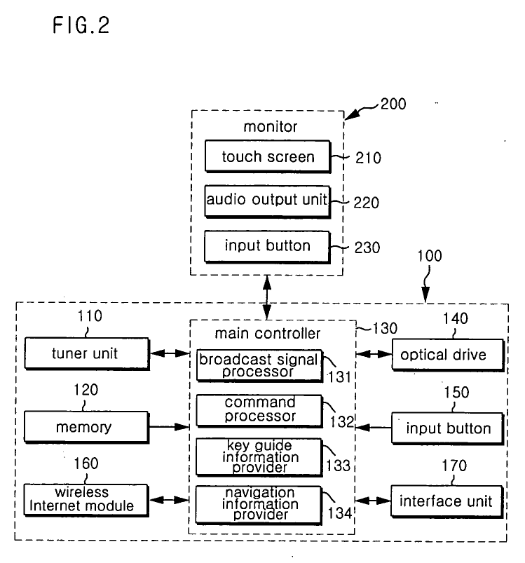

For example, the main body 100 may be embodied in similar shape to a car audio unit. The main body 100 will now be described in detail with reference to FIG. 2.

FIG. 2 is a block diagram schematically showing the main body and the monitor of FIG. 1. As shown in FIG. 2, the main body 100 includes a tuner unit 110, a memory 120, and a main controller 130. The tuner unit 110 selectively receives and outputs a terrestrial TV or radio signal. The memory 120 stores an operating program (or an operating system) for the in-vehicle multifunctional information device 10, a plurality of user applications, and a plurality of content items. The main controller 130 controls the overall operation of the in-vehicle multifunctional information device 10. The main body 100 according to the present invention further includes an optical drive 140 that accesses data stored in optical storage media such as CD and DVD and a plurality of input buttons 150 that includes a power button to activate and deactivate the main body 100.

The tuner unit 110 includes radio and TV tuners that selectively receive and output a terrestrial broadcast signal. The radio tuner selectively receives and outputs a radio broadcast desired by the user from among terrestrial broadcasts input through a radio antenna provided on the main body 100. The TV tuner selectively receives and outputs a TV broadcast desired by the user from among terrestrial broadcasts input through a TV antenna provided on the main body 100.

The memory 120 may be embodied as a high capacity hard disk for computer systems. More preferably, the memory 120 is embodied as a hard disk for laptop computers to reduce the size of the main body 100.

The memory 120 stores an operating system such as MS Windows or Linux for operating the in-vehicle multifunctional information device 10. The memory 120 also stores user applications that operate in conjunction with the operating program to provide video and audio content and various other types of content. The memory 120 also stores video and audio data and various user data compressed according to a coding method such as MP3 and MPEG4 that are to be reproduced through user applications. Access to such data stored in the memory 120 is controlled by the operating program run by the main controller 130.

For example, the optical drive 140 is implemented as a drive that can handle CD-ROM and DVD-ROM or CD and DVD. The main controller 130 accesses data stored in an optical disc through the optical drive 140 and provides the data to the user through the monitor 200. The optical drive 140 is known in the art and a detailed description thereof is omitted herein.

The main controller 130 controls the overall operation of the in-vehicle multifunctional information device 10 and includes a broadcast signal processor 131 and a command processor 132. The broadcast signal processor 131 extracts video or audio data from a TV or radio signal output from the tuner unit 110 and provides the extracted video or audio data to the monitor 200. The command processor 132 provides, through the monitor 200, a user interface provided as the operating program runs, and processes an operating command input through the monitor 200 or the input panel 300.

When a radio function is selected by the user through the operating program, the broadcast signal processor 131 separates an audio signal from a radio broadcast signal received by the radio tuner, converts the separated audio signal into an electrical signal, and outputs the electrical signal to the monitor 200.

When a TV function is selected by the user through the operating program, the broadcast signal processor 131 processes and outputs a TV broadcast signal received by the radio tuner to the monitor 200. The TV broadcast signal is received as a signal that combines video and audio signals. The broadcast signal processor 131 includes a video/audio separation circuit that separates the received TV broadcast signal into video and audio signals. The video and audio signals separated by the video/audio separation circuit are output to the monitor 200.

According to a drive command for the main body 100, the command processor 132 accesses and runs the operating program stored in the memory 120 to control the overall operation of the main body 100. According to the operating program, the command processor 132 runs a user application selected by the user and reproduces and provides content including multimedia data stored in the memory 120 or the optical drive 140.

The command processor 132 also allows the main body 10 to enter a standby mode or to stop operation according to an operation control command transmitted from the input panel 300.

According to an additional aspect of the present invention, the main controller 130 according to the present invention may further include a key guide information provider 133 that provides guide information of input keys of the input panel 300 that are used as a different type of keys depending on the user application.

Specifically, the key guide information is information of input keys of the input panel 300 that are assigned a different type of functions depending on a user application that is selected and driven by the user. For example, the key guide information provider 133 provides images of a plurality of keys provided on the input panel 300 and provides text of the guide information of the respective functions of the keys.

When the input keys of the input panel 300 are set as navigation keys 310, the key guide information provider 133 displays images of the navigation keys 310 on the monitor 200 and provides text information of the respective functions assigned to the navigation keys.

As the information of keys that are assigned different functions depending on the application is provided to the user, the user can more easily use the in-vehicle multifunctional information device 10.

According to an additional aspect of the present invention, the in-vehicle multifunctional information device according to the present invention supports a navigation function. In this aspect, the in-vehicle multifunctional device information 10 according to the present invention further includes a GPS antenna that is detachably coupled to the main body 100 and receives and outputs a GPS signal output from a GPS satellite, and the main controller 130 further includes a navigation information provider 134 that receives a GPS signal output from the GPS antenna and calculates a current position of the vehicle, and displays travel information of the vehicle based on the calculated position on the monitor 200.

The GPS antenna, which is detachably coupled to the main body 100, receives and outputs a GPS signal to the navigation information provider 134. The navigation information provider 134 receives a GPS signal and calculates a current position of the vehicle. The navigation information provider 134 then searches map information in the memory 120 based on the calculated current position to retrieve and output a map of an area within a specific distance from the calculated current position, together with the current position and travel direction of the vehicle, to the monitor 200. The navigation system is known in the art and thus a detailed description thereof is omitted herein.

According to another aspect of the present invention, the in-vehicle multifunctional information device 10 according to the present invention includes a wireless Internet module 160 that transmits and receives data to and from a wireless Internet access point installed at a specific position to provide Internet services to the user.

The wireless Internet module 160 establishes a connection with an access point installed in an area, where a wireless Internet service such as the Netspot service provided by Korea Telecom (KT) is available, and transmits and receives data to and from the access point through a wireless Internet protocol to provide wireless Internet services to the user. This allows the user to receive an Internet service without separate equipment in an area where the wireless Internet service is provided.

According to another aspect of the present invention, the in-vehicle multifunctional information device 10 according to the present invention further includes an interface unit 170 that transmits and receives data to and from an external input or output device.

For example, the interface unit 170 may be embodied as a USB port. The interface unit 170 can be connected to a variety of external devices such as storage devices, mobile communication terminals, and cameras that support USB communication. The interface unit 170 may also be embodied as an RS232 or other conventional serial port.

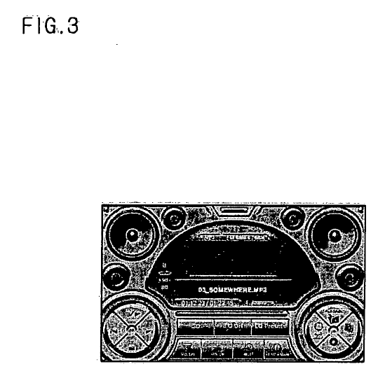

The monitor 200 is housed in a receiving space defined in the in-vehicle multifunctional information device 10. When a command to drive the device is input or when the engine of the vehicle starts, the monitor 200 is slid out of the receiving space and then displays video and audio data output from the main body 100. The monitor 200 will now be described in more detail with reference to FIGS. 2 and 3.

FIG. 3 is a view schematically illustrating a user application that is provided through the monitor according to a preferred embodiment of the present invention. As shown in FIG. 2, the monitor 200 includes a touch screen 210 and at least one audio output unit 220. The touch screen 210 displays a user interface or content output from the main body 100, and receives an operating command through the user interface and outputs the operating command to the main body 100. The audio output unit 220 outputs audio data output from the main body 100. The monitor 200 may further include input buttons 230 such as a power button and a volume button to adjust the volume of audio output through the audio output unit 220.

The touch screen 210 provides a user interface provided by an operating program run by the command processor 132 of the main body 100 and displays a plurality of user application menus registered in the main body 100 and stored in the memory 120. The touch screen 210 uses pressure sensor lines closely arranged in a lattice pattern on the surface of a liquid crystal display (LCD) device of a specific size to transfer a pressed position on the screen to the command processor 132 of the main body 100.

In another method, the surface of the LCD device is charged, and the amount of charges lost when a position on the screen is touched is detected using sensors arranged around the surface to determine the touched position. In an alternative method, infrared light emitting diodes (LED) are arranged around the screen to form an infrared light lattice, and, when a position on the screen is touched, the absence of infrared light that is blocked by the touching is detected to determine the touched position. Using these methods, the touch screen 210 detects and transfers the touched position to the command processor 132 to perform a function corresponding to the input position.

The input function of the touch screen 210 supports all features of the pointing device function such as click, draw, and scroll supported by a mouse for general computers. The command processor 132 associates a position detected on the touch screen 210 with an operating command displayed on the user interface to process the operating command.

The audio output unit 220 may be a speaker that converts audio data output from the broadcast signal processor 131 of the main body 100 and audio data output during the operation of a variety of user applications into audible sound.

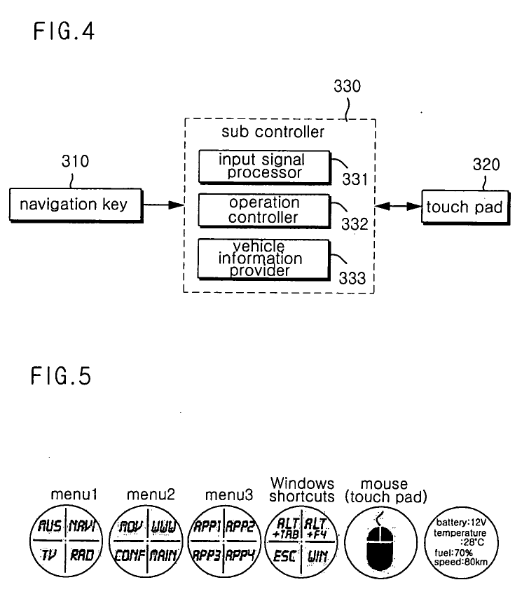

The input panel 300 is attached to the front side of the main body 100 by hinging an end thereof to the main body 100 such that the input panel 300 opens and closes. The input panel 300 detects starting or stopping of the engine of the vehicle and controls the operation of the in-vehicle multifunctional information device 10, displays user application menus that can be provided by the main body 100, and provides input selection information to the main body 100. The input panel 300 will now be described in more detail with reference to FIGS. 4 and 5.

FIG. 4 is a schematic block diagram of the input panel shown in FIG. 1, and FIG. 5 is a view schematically showing menus displayed on the touch pad of the input panel shown in FIG. 4. As shown in FIG. 4, the input panel 300 includes one or more navigation keys 310 and a touch pad 320, in addition to the sub controller 330. The navigation keys 310 receive an operating command from the user. The touch pad 320 displays state information of the main body 100, state information of the vehicle provided by a vehicle state detector, and a user application menu provided by the main body 100. The touch pad 320 receives and outputs selection information of an application on the menu from the user. The touch pad 320 supports a pointing device function of a user interface provided through the monitor 200. The sub controller 330 includes an input signal processor 331 that processes an input signal from the touch pad 320 and an operation controller 332 that detects starting or stopping of the engine of the vehicle and controls the operation of the in-vehicle multifunctional information device 10.

Preferably, two navigation keys 310 are provided at the left and right sides of the touch pad 320 that is provided on the front side of the input panel 300 at the center thereof. One of the two navigation keys 310 is used to perform multimedia player functions such as play, pause, stop, next track, and previous track of multimedia data. The other navigation key 310 functions both as arrow direction keys and an enter key of a keyboard.

The touch pad 320 is embodied as a small touch screen that displays state information of the main body 100, state information of the vehicle, and a user application menu provided by the main body 100, receives and outputs selection information of an application on the menu from the user, and supports a pointing device function of a user interface provided through the monitor 200.

The touch pad 320 supports a mode function that provides user applications provided by the main body 100 in a stepwise manner. When the mode function is selected by the user, the touch pad 320 displays menus of user applications, sequentially from higher to lower menus, so that the user can easily select a user application on each menu such as a music, video, or navigation application.

In addition to the input function for selection desired functions, the touch pad 320 supports a pointing device function to move a pointer on the screen of the monitor 200, in place of the mouse. The touch pad 30 also provides state information of the main body 100 including, for example, the level of power (or voltage) supplied to the main body 100 and a change in the temperature of the main body 100.

The touch pad 320 operates in conjunction with state detectors provided on the vehicle, and receives and displays, for example, vehicle battery information, fuel state information, vehicle temperature information, and vehicle speed information from the state detectors.

The sub controller 330 includes an input signal processor 331 and an operation controller 332. The input signal processor 331 controls the overall operation of the input panel 300 and processes an input signal from the touch pad 320. The operation controller 332 detects starting or stopping of the engine of the vehicle and controls the operation of the in-vehicle multifunctional information device 10.

The input signal processor 331 receives or collects a user application provided by the main body 100 and displays the user application on the touch pad 320. The input signal processor 331 provides selection information of a user application, which has been input through the touch pad 320, and position information, which the user has input through the touch pad 320 using the pointing device function, to the command processor 132 of the main body 100.

The operation controller 332 detects starting or stopping of the engine of the vehicle and controls the operation of the in-vehicle multifunctional information device 10. When the driver starts the engine of the vehicle, the operation controller 332 detects the starting of the engine of the vehicle and transmits a drive command to the main body 100, and the main controller 130 of the main body 100 receives the drive command and drives each component of the main body 100.

According to an aspect of the present invention, when stopping of the engine of the vehicle is detected, the operation controller 332 according to the present invention allows the operation of the main body 100 and the monitor 200, other than the sub controller 330, to be kept in standby mode. In the standby mode, the operation of the main body 100 is not completely stopped and instead, as with the power management function of Windows, the operation of internal circuitry of the main body 100 is stopped while the RAM operates to drive the controller to consume the minimum power required to drive the controller.

Even if the engine of the vehicle stops and the main body 100 and the monitor 200 are kept in the standby mode, the sub controller 330 operates to continuously detect the state of the vehicle, so that, when the user restarts the engine of the vehicle, the in-vehicle multifunctional information device 10 can be used in a short time without any delay due to the booting process of the operating program. Thus, the sub controller 330 is preferably embodied as a small, low power, temperature-resistant processing unit.

According to an aspect of the present invention, the operation controller 332 according to the present invention detects the level of a battery that supplies power to the in-vehicle multifunctional information device 10 and stops the operation of the in-vehicle multifunctional information device 10 when the detected battery level is a specific level or less.

This prevents electrical damage to the in-vehicle multifunctional information device 10 caused by abnormal power supplied to the in-vehicle multifunctional information device 10 and also prevents discharge of the battery of the vehicle caused by unnecessary operation of the in-vehicle multifunctional information device 10.

According to another aspect of the present invention, the sub controller 330 according to the present invention further includes a vehicle information provider 333 that receives state information of the vehicle, including vehicle battery information, fuel state information, vehicle temperature information, and vehicle speed information, which are provided from detectors for detecting states of the vehicle, and displays the received state information of the vehicle on the touch pad 320.

Specifically, the vehicle information provider 333 operates in conjunction with detectors such as a power (or voltage) detection circuit for detecting the power (or voltage) level of a battery provided in the vehicle, a fuel gauge for measuring the fuel level, a thermometer for measuring the temperature of the engine, and a speedometer for measuring the speed of the vehicle, and displays state information of the vehicle such as vehicle battery information, fuel state information, vehicle temperature information, and vehicle speed information, which are provided from the detectors, on the touch pad 320.

This allows the user to check, at a glance, the states of the vehicle on the touch pad 320 of the input panel 300.

In addition, the sub controller 330 according to the present invention detects power supplied to the main body 100 and the temperature of the main body 100 that varies as the main body 100 operates, and provides the detected power and temperature to the user through the touch pad 320. The sub controller 330 can determine whether or not power not suitable for driving the main body 100, for example excessive power or power lower than the minimum power required to drive the main body 100, is being supplied to the main body 100 or whether or not the temperature of the main body 100 is out of a suitable temperature range for driving the main body 100, and can control the operation of the main body 100 according to the determination.

The input panel 300 detects the operating state of the main body 100 and controls the operation of the main body 100 according to the detected operating state in the above manner, thereby preventing damage to the main body 100 and thus keeping the system more stable.

As is apparent from the above description, the present invention provides an in-vehicle multifunctional information device that not only functions as a car audio unit but also provides a variety of multimedia content to the user so that there is no need to install a number of required multimedia devices in the vehicle. Main and sub controllers are separately provided in the main body and the input panel to separately control the main body and the input panel. The main body controls the overall operation of the in-vehicle multifunctional information device while starting or stopping of the engine of the vehicle is detected and the main body is driven according to the detection. This avoids inconvenience to the user having to input a drive command of the in-vehicle multifunctional information device.

In addition, a variety of state information of the vehicle is provided through the input panel so that the driver can check states of the vehicle at a glance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An in-vehicle multifunctional information device comprising:
a main body including a main controller for controlling overall operations of the in-vehicle multifunctional information device, selectively receiving and outputting a broadcast signal, and providing a plurality of user applications;
a monitor for outputting a broadcast signal output from the main body or outputting content reproduced by a user application; and
an input panel coupled to a front side of the main body such that the input panel opens and closes, the input panel including a sub controller for displaying a user application menu provided from the main body, receiving and processing an operating command input by a user, and detecting starting or stopping of an engine of a vehicle and controlling an operation of the main body.

2. The device according to claim 1, wherein the input panel further includes:
at least one navigation key for receiving an operating command from the user; and
a touch pad for displaying state information of the vehicle and a user application menu provided by the main body and receiving and outputting an operating command from the user,
the sub controller including:
an input signal processor for processing an input signal from the touch pad; and
an operation controller for detecting starting or stopping of the engine of the vehicle and controlling an operation of the in-vehicle multifunctional information device.

3. The device according to claim 2, wherein, when stopping of the engine of the vehicle is detected, the operation controller allows the main body and the monitor, other than the sub controller, to be kept in standby mode.

4. The device according to claim 3, wherein the operation controller detects a battery level of the vehicle and stops the operation of the in-vehicle multifunctional information device when the detected battery level is a specific level or less.

5. The device according to claim 2, wherein the sub controller further includes:
a vehicle information provider for receiving state information of the vehicle provided from a detector that detects a state of the vehicle and displaying the received state information on the touch pad.

6. The device according to claim 5, wherein the vehicle state information includes vehicle battery information, fuel state information, vehicle temperature information, and vehicle speed information.

7. The device according to claim 1, wherein the main body further includes:
a tuner unit for selectively receiving and outputting a TV or radio signal; and
a memory for storing an operating program for the in-vehicle multifunctional information device, a plurality of user applications, and a plurality of content items,
the main controller including:
a broadcast signal processor for extracting video or audio data from a TV or radio signal output from the tuner unit and providing the extracted video or audio data to the monitor;
a content provider for reproducing content read from the memory; and
a command processor for providing, through the monitor, a user interface provided as the operating program runs and processing an operating command input through the input panel.
